(19) United States
(12) Patent Application Publication
(10) Pub. No.: US 2025/0335884 A1
(43) Pub. Date: Oct. 30, 2025

(54) INSTANT CHECK REMEMBRANCE

(71) Applicant: Capital One Services, LLC, McLean, VA (US)

(72) Inventors: Keegan FRANKLIN, Tucson, AZ (US); Jacqueline Nicole TERO, Brooklyn, NY (US); Patrick BABCOCK, Boston, MA (US)

(73) Assignee: Capital One Services, LLC, McLean, VA (US)

(21) Appl. No.: 18/645,645

(22) Filed: Apr. 25, 2024

(51) Int. Cl. G06Q 20/10; G06Q 20/38

(52) U.S. Cl. CPC G06Q 20/10; G06Q 20/389

(57) ABSTRACT

A computer implemented method, system, and non-transitory computer-readable device that may be used in a remote deposit environment. Upon receiving a user request, based on interactions with the UI, the method implements an electronic deposit of a financial instrument by activating a camera on the client device to generate a live video stream of image data of a field of view of at least one camera, wherein the live video stream includes imagery of at least a portion of each side of the financial instrument. The method continues by extracting data fields based on the formation of image objects from one or both sides of the financial instrument from the live video stream of image data. The extracted data fields are converted, based on a payor agreement, into a recurring electronic funds transfer (EFT) schedule for future payments similar to the check.

### BACKGROUND

As financial technology evolves, banks, credit unions and other financial institutions have found ways to make online banking and digital money management more convenient for users. Mobile banking apps may let you check account balances and transfer money from your mobile device. In addition, a user may deposit paper checks from virtually anywhere using their smartphone or tablet. However, users may have to take pictures and have them processed remotely.

### BRIEF DESCRIPTION OF THE DRAWINGS

The accompanying drawings are incorporated herein and form a part of the specification.

FIG. 1 illustrates an example remote deposit, according to some embodiments and aspects.

FIG. 2 illustrates example remote deposit Optical Character Recognition (OCR) segmentation, according to some embodiments and aspects.

FIG. 3 illustrates a block diagram of a remote deposit system architecture, according to some embodiments and aspects.

FIG. 4 illustrates an example diagram of a client computing device, according to some embodiments and aspects.

FIG. 5 illustrates an example diagram of a recurring payment system, according to some embodiments and aspects.

FIG. 6 illustrates an example flow diagram of a recurring payment system, according to some embodiments and aspects.

FIG. 7 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, computer program product embodiments, and/or combinations and sub-combinations thereof, for financial instrument capture on a mobile device or desktop computing device with check remembrance for recurring transactions. In a non-limiting example, a payor (e.g., renter) may write a check each month for a recurring expense (e.g., rent). A payee (e.g., landlord) receiving the check may subsequently remotely deposit the check each month and then wait for a clearing period to receive funds. This process may be repetitive, with varying time periods for funds availability depending on when the check is written, mailed, received, deposited, funds made available, etc. In addition, current approaches require the consumer and the landlord to repeat this process each month.

Continuing with the above example, the technology disclosed herein, in various embodiments, may allow the landlord, during the remote deposit process, to request from the renter a recurring monthly electronic funds transfer similar to the current check, as based on data fields extracted during the remote deposit process. The renter may accept the landlord's request and the system may subsequently generate a recurring electronic funds transfer (EFT) each month, thereby eliminating the renter's need to write additional checks each month and the landlord's requirement to remotely deposit them. While described for simplicity for a renter and landlord, the technology disclosed may be applied to any payor-payee transaction without departing from the scope of the technology disclosed herein. In some embodiments, the EFT may occur during the initial remote check deposit and provide a real-time transfer of funds, without waiting an extended period to clear the funds.

Mobile check deposit is a convenient way to deposit funds using a customer's mobile device or laptop. As technology and digital money management tools continue to evolve, the process has become safer and easier. Mobile check deposit is a way to deposit a financial instrument, e.g., a paper check, through a banking app using a smartphone, tablet, laptop, etc. In existing systems, mobile deposit may request a customer to capture a plurality of pictures of a check using, for example, their smartphone or tablet camera and upload it through a mobile banking app running on the mobile device. Deposits commonly include personal, business, or government checks.

Many banks and financial institutions use advanced security features to keep an account safe from fraud during the mobile check deposit workflow. For example, security measures may include encryption and device recognition technology. In addition, remote check deposit apps typically capture check deposit information without storing the check images on the customer's mobile device (e.g., smartphone). Mobile check deposit may also eliminate or reduce typical check fraud as a thief of the check may not be allowed to subsequently make use of an already electronically deposited check, whether it has cleared or not and may provide an alert to the banking institution of a second deposit attempt. In addition, fraud controls may include mobile security alerts, such as mobile security notifications or SMS text alerts, which can assist in uncovering or preventing potentially fraudulent activity.

The disclosed technology may be used to process images of documents during transactions, such as assisting, in real-time or near real-time, a customer to electronically deposit a financial instrument, such as a check. The images may be formed into image objects and be processed by an Optical Character Recognition (OCR) system. OCR includes the electronic or mechanical conversion of images of typed, handwritten, or printed text into machine-encoded text, whether from a scanned document, a photo of a document, a scene photo, a video stream of image data, etc. Using the technology described herein, check data fields (e.g., check amount, signature, MICR line, account number, etc.) may be extracted in real-time or near-real-time from a live video stream of a check, or portions of the check (e.g., partial check images). While described in the context of check deposit processing, the disclosed technology may be applied to any other financial instrument.

In current remote deposit systems and processes, computer-based (e.g., laptop) or mobile-based (e.g., mobile device) technology allows a user to initiate a document uploading process for uploading an image(s) or other electronic versions of a document to a backend system (e.g., a document processing system) for various purposes, including evaluating the quality of the captured image(s). This current process has disadvantages, such as, requiring the customer to capture and communicate check imagery and, if determined to be of poor quality, following-up with additional images. This is inefficient and consumes system and network resources that otherwise could be allocated to other tasks. Alternatively, a frustrated user may take their deposit to another financial institution, causing a potential duplicate presentment or fraud issue.

In some embodiments and aspects disclosed herein, the technology described herein actively processes camera imagery of a financial instrument located within the camera field of view, allowing, for example, the user to simplify the image generation process. In one aspect, live camera imagery is streamed as encoded data configured in byte arrays (e.g., as a byte array output video stream object). This imagery may be processed continuously, or alternatively, the imagery may be stored temporarily within memory of the mobile device, such as, in a frame or video buffer.

Technical solutions disclosed herein may eliminate requiring the customer to capture and communicate individual images, and further to eliminate this process for multiple payments. Thus, the process may be more efficient, require less system and network resources, improve user experience, and may reduce instances of accidental duplicate check presentation. In some embodiments, the technology described herein continuously evaluates a quality of a video stream of image data from an activated camera of a mobile device or other customer device. One or more high quality image frames (e.g., entire image of check image), or portions thereof, may be OCR processed to extract data fields locally or, alternatively, in a remote OCR process.

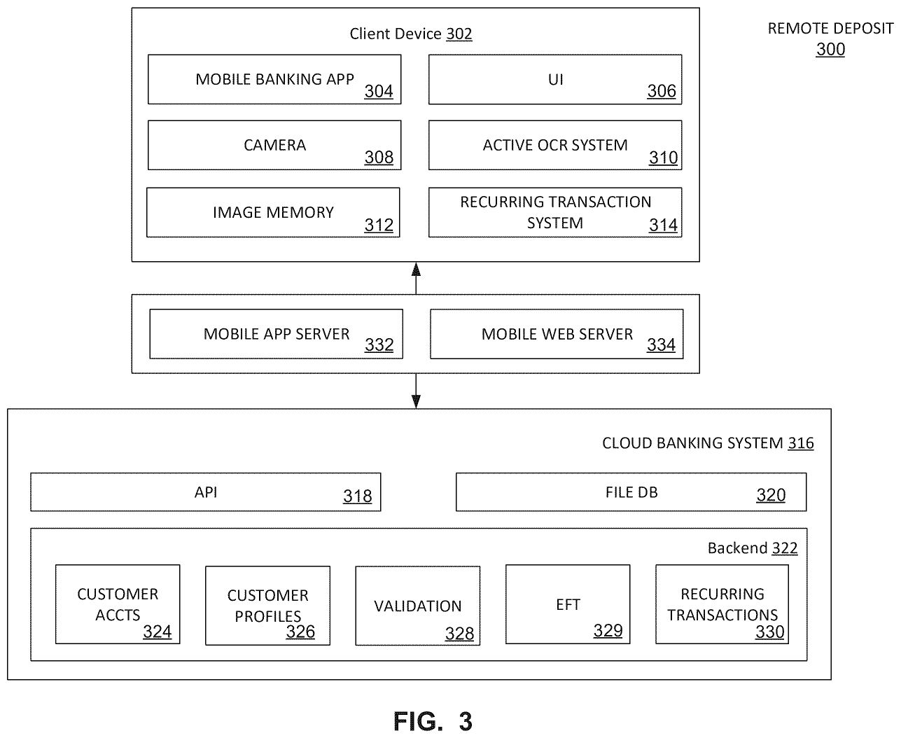

In some embodiments and aspects disclosed herein, the OCR process may be implemented with an active OCR process using a mobile device, instead of after submission of imagery to a backend remote deposit system. In some aspects, the technology disclosed herein implements “Active OCR” as further described in U.S. application Ser. No. 18/503,778, entitled “Active OCR,” filed Nov. 7, 2023, and incorporated by reference in its entirety. Active OCR, as further described in FIGS. 3-6, includes performing OCR processing on image objects formed from a raw live video stream of image data originating from an activated camera on a client device. The image objects may capture portions of a check or an entire image of the check. As a portion of a check image is formed into a byte array, it may be provided to the active OCR system to extract any data fields found within the byte array in real-time or near real-time. In a non-limiting example, if the live video streamed image data contains an upper right corner of a check formed in a byte array, the byte array may be processed by the active OCR system to extract the origination date of the check. However, other known and future OCR applications may be substituted without departing from the scope of the technology disclosed herein

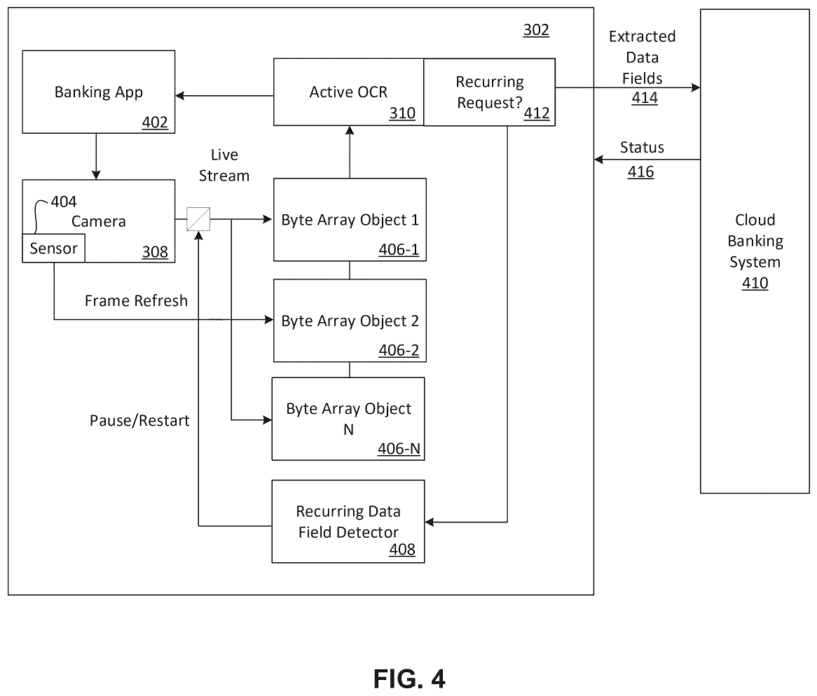

Various aspects of this disclosure may be implemented using and/or may be part of remote deposit systems shown in FIGS. 3-4. It is noted, however, that this environment is provided solely for illustrative purposes, and is not limiting. Aspects of this disclosure may be implemented using and/or may be part of environments different from and/or in addition to the remote deposit system, as will be appreciated by persons skilled in the relevant art(s) based on the teachings contained herein. An example of a remote deposit shall now be described.

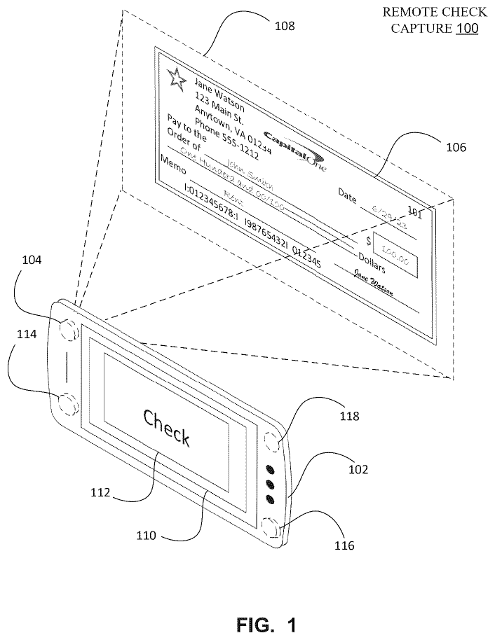

FIG. 1 illustrates an example remote check capture 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106, may be a personal check, paycheck, or government check, to name a few. In some embodiments, a customer will initiate a remote deposit check capture from their mobile computing device (e.g., smartphone) 102, but other digital video camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer will select a bank account (e.g., checking or savings) into which the funds specified by the check are to be deposited. Content associated with the document include the funds or monetary amount to be deposited to the customer's account, the issuing bank, the routing number, and the account number. Content associated with the customer's account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104 (e.g., open a camera port). One skilled in the art would understand that variations of this approach or functionally equivalent alternative approaches may be substituted to initiate a mobile deposit.

In a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, active OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

Using the camera 104 function on the mobile computing device 102, the customer captures live video from a field of view 108 that includes at least a portion of one side of a check 112. Typically, the camera's field of view 108 will include at least the perimeter of the check. However, any camera position that generates in-focus video of the various data fields located on a check may be considered. Resolution, distance, alignment, and lighting parameters may require movement of the mobile device until a proper view of a complete check, in-focus, has occurred. In some aspects, camera 104, LIDAR sensor 114, microphone 116, and/or gyroscope sensor 118, may capture image, distance, audio data, and/or angular position to assist, for example, in detecting a check flipping action.

An application running on the mobile computer device may offer suggestions or technical assistance to guide a proper framing of a check within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera can be remote to the mobile computing device 102. In an alternative embodiment, the remote deposit is implemented on a desktop computing device with an accompanying digital camera.

Additional remote deposit sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've captured video of the front of the check, flip the check to capture video of the back of the check,” “Do you accept the funds availability schedule?,” “Swipe the Slide to Deposit button to submit the deposit,” “Your deposit request may have gone through, but it's still a good idea to hold on to your check for a few days,” “keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

In some embodiments, after providing at least a subset of OCR extracted data fields to a remote deposit system, the payee may request a recurring payment using at least a portion of these data fields. For example, the amount, payor, payee, date of recurrence, to name a few, may be used to configure future electronic reoccurring transfers (e.g., EFTs) to the payee's account from the payor's account. In addition, a message will be communicated to the payor requesting acceptance or refusal of the reoccurring payment request and a return acknowledgement or denial message to the payee during or subsequent to the remote deposit process. For example, the payee may complete the remote deposit process for a current check and wait for a response to their request for recurring payments. While described for scheduling recurring payments on a same date as the check, a selectable date field or date range may be available to the payee to select for recurring payment dates. For example, the date may be any of: a recurring date equal to an OCR extracted date field of the physical financial document (e.g., check), a recurring date range proximate to an OCR extracted date field of the physical financial document, a payee requested date, a payor requested date, or a bank selected date.

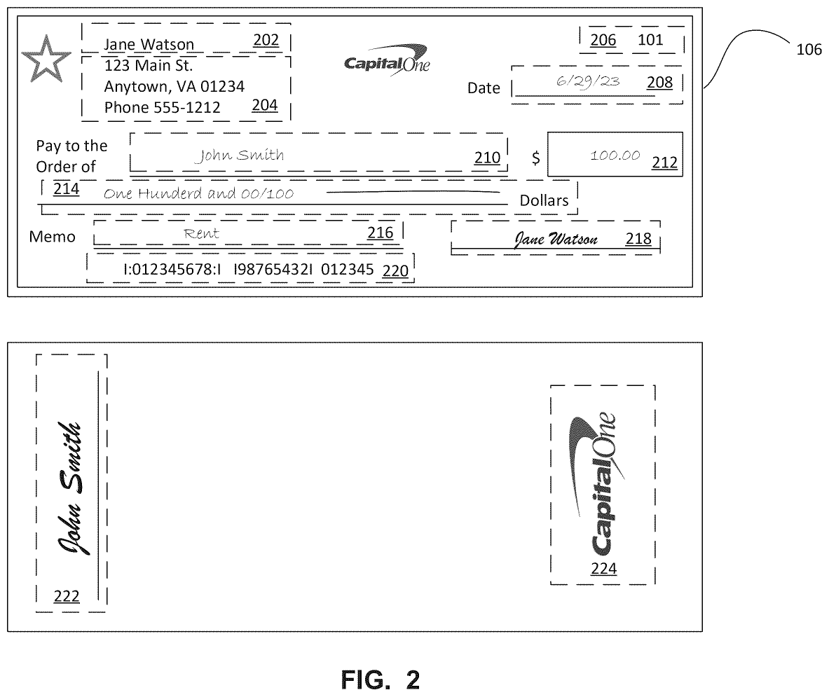

FIG. 2 illustrates example remote deposit OCR segmentation, according to some embodiments and aspects. Depending on check type, a check may have a fixed number of identifiable fields. For example, a standard personal check may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number, and finally, the payer customer's signature 218. Back side identifiable fields may include, but are not limited to, payee signature 222 and security fields 224, such as a watermark.

While a number of fields have been described, it is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in the mobile banking app running on the mobile device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In one embodiment, active OCR processing of a live video stream of check imagery may include implementing instructions resident on the customer's mobile device to process each of the field locations on the check as they are detected or systematically (e.g., as an ordered list extracted from a byte array output video stream object). For example, in some aspects, the video streaming check imagery may reflect a pixel scan from left-to-right or from top-to-bottom with data fields identified within a frame of the check as they are streamed.

In one non-limiting example, the customer holds their smartphone over a check (or checks) to be deposited remotely while the live video stream imagery may be formed into image objects, such as, byte array objects (e.g., frames or partial frames), ranked by confidence score (e.g., quality), and top confidence score byte array objects sequentially OCR processed until data from each of required data fields has been extracted as described in U.S. application Ser. No. 18/503,787, entitled Burst Image Capture, filed Nov. 7, 2023, and incorporated by reference in its entirety herein. Alternatively, the imagery may be a blend of pixel data from descending quality image objects to form a higher quality (e.g., high confidence) blended image that may be subsequently OCR processed, as per U.S. patent application Ser. No. 18/503,799 filed Nov. 7, 2023, entitled Intelligent Document Field Extraction from Multiple Image Objects, and incorporated by reference in its entirety herein.

In another non-limiting example, fields that include typed information, such as the MICR line 220, check number 206, payer customer name 202 and address 204, etc., may be OCR processed first from the byte array output video stream objects, followed by a more complex or time intensive OCR process of identifying written fields, which may include handwritten fields, such as the payee field 210, signature 218, to name a few.

In another example embodiment, artificial intelligence (AI), such as machine-learning (ML) systems may train a confidence model (e.g., recurring check history confidence) to recognize repeating check deposits from a payor to a payee. In one aspect, the payee or payor may be prompted to generate or select a recurring payment based on a ML model's high confidence of a similar repeating transaction. The ML model would provide a technical solution for a payee who did not recognize a recurring transaction opportunity (e.g., processes large numbers of checks).

Alternatively, or in addition to, the ML models may be trained to recognize a quality of a frame or partial frame of image data, or an OCR model(s) to recognize characters, numerals or other check data within the data fields of the video streamed imagery. Machine learning may involve computers learning from data provided so that they carry out certain tasks. For more advanced tasks, it can be challenging for a human to manually create the needed algorithms. This may be especially true of teaching approaches to correctly identify patterns. The discipline of machine learning therefore employs various approaches to teach computers to accomplish tasks where no fully satisfactory algorithm is available. In cases where vast numbers of potential answers exist, one approach, supervised learning, is to label some of the correct answers as valid or successful. For example, a high quality image may be correlated with a confidence score based on previously assigned quality ratings of a number of images. This may then be used as training data for the computer to improve the algorithm(s) it uses to determine future successful outcomes. The confidence model and OCR model may be resident on the mobile device and may be integrated with or be separate from a banking application (app). The models may be continuously updated by future images or transactions used to train the model(s).

In some embodiments, computer vision algorithms for OCR processing may use large language models (LLM). A large language model is a language model characterized by emergent properties enabled by its large size. As language models, they work by taking an input text and repeatedly predicting the next token or word. They may be built with artificial neural networks, pre-trained using self-supervised learning and semi-supervised learning, typically containing tens of millions to billions of weights. In some aspects, LLM includes Natural Language Processing (NLP). One goal is a computer capable of “understanding” the contents of images, including the contextual nuances of the language within them. The technology can then accurately extract information and insights contained in the images as well as categorize and organize the images or fields within images themselves. LLM and NLP functionality may be implemented on a remote deposit platform to train and improve the previously described ML OCR models that may be operative with the mobile device for the localized active OCR processing.

ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data,” in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific process to capture relationships between concepts (e.g., image clarity vs. recognition of specific characters or numerals) and a success history. The classifier (discriminator) is trained to distinguish (recognize) variations. Different variations may be classified to ensure no collapse of the classifier and so that variations can be distinguished.

In some aspects, machine learning models are trained on a remote machine learning platform (not shown) using other customer's transactional information (e.g., previous remote deposit transactions). For example, large training sets of remote deposit imagery may be used to normalize prediction data (e.g., not skewed by a single or few occurrences of a data artifact). Thereafter, a predictive model(s) may classify a specific image against the trained predictive model to predict an imagery check position (e.g., front-facing, flipped, back-facing), detect a check's edges and corners, text, numbers, or generate a confidence score. In one embodiment, the predictive models are continuously updated as new remote deposit financial transaction imagery becomes available.

In some aspects, a ML engine may continuously change weighting of model inputs to increase customer interactions with the remote deposit procedures. For example, weighting of specific data fields may be continuously modified in the model to trend towards greater success, where success is recognized by correct data field extractions or by completed remote deposit transactions. Conversely, input data field weighting that lowers successful interactions may be lowered or eliminated.

FIG. 3 illustrates a remote deposit system architecture 300, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as checks. The client device 302 is configured to communicate with a cloud banking system 316 to complete various phases of a remote deposit as will be discussed in greater detail hereafter.

In aspects, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 is a computer program or software application designed to run on a mobile device such as a phone, tablet, or watch. However, in a desktop application implementation, a mobile banking app equivalent may be configured to run on desktop computers, and web applications, which run in web browsers rather than directly on a mobile device. Apps are broadly classified into three types: native apps, hybrid and web apps. Native applications are designed specifically for a mobile operating system, such as, iOS or Android. Web apps are designed to be accessed through a browser. Hybrid apps may function like web apps disguised in a native container.

Financial instrument imagery may originate from, but is not limited to, video streams (e.g., series of pixels or frames). A customer using a client device 302, operating a mobile banking app 304 through an interactive User interface (UI) 306, frames at least a portion of a check (e.g., identifiable fields on front or back of check) with a camera 308 (e.g., camera's field of view).

In one aspect, the camera imagery is video streamed as encoded text, such as a byte array. Alternatively, or in addition to, the video is buffered by storing (e.g., at least temporarily) as images or frames in computer memory. For example, live video streamed check imagery from camera 308 is stored locally in image memory 312, such as, but not limited to, a frame buffer, a video buffer, a video streaming buffer, or a virtual buffer. In yet another aspect, an image is simply captured using camera 308. In a first non-limiting example, by first detecting pixels in a video stream, or image byte array, which contain typed or written image components, with, for example, darker, higher contrast, and common black or blue color values, a confidence score may be calculated based on an overall perceived individual image quality. In some aspects, the confidence score may be predicted by a ML model trained on previous images, assigned confidence scores, and corresponding quality ratings. Alternatively, or in addition to, in one aspect, a total pixel score for each image may be calculated. For example, in some aspects, only pixels in a range of pixel values (e.g., range of known marking pixel values, such as 0-50) may be processed, without processing the remaining pixels. For example, those pixels that only include a high pixel value (e.g., lighter pixel grey values), such as, in a background section of the check may not be included in a generated confidence score. In some aspects, pixels that capture preprinted border pixels also may not be considered in the confidence score. In this aspect, the Machine Learning (ML) models may be trained to recognize the values that represent the written or typed information as well as the preprinted borders. For example, using machine learning, thousands or millions of images may be processed to learn to accurately recognize and categorize these pixels. While described for quality scored imagery, OCR processing may be performed without scoring without departing from the scope of the technology described herein.

In some embodiments, active OCR system 310, resident on the client device 302, processes the highest confidence images based on live video streamed check imagery from camera 308 to extract data by identifying specific data located within known sections of the check to be electronically deposited. In one non-limiting example, single identifiable fields, such as the payer customer name 202, MICR data field 220 identifying customer and bank information (e.g., bank name, bank routing number, customer account number, and check number), date field 208, check amount 212 and written amount 214, and authentication (e.g., payee signature 222) and security fields 224 (e.g., watermark), etc., shown in FIG. 2, are processed by the active OCR system 310.

Active OCR system 310 communicates data extracted from the one or more data fields during the active OCR operation to cloud banking system 316, shown in FIG. 3. For example, the extracted data identified within these fields is communicated to file database (DB) 320 either through a mobile app server 332 or mobile web server 334 depending on the configuration of the client device (e.g., mobile or desktop). In one aspect, the extracted data identified within these fields is communicated through the mobile banking app 304.

Alternatively, or in addition to, a thin client (not shown) resident on the client device 302 processes extracted fields locally with assistance from cloud banking system 316. For example, a processor (e.g., CPU) implements at least a portion of remote deposit functionality using resources stored on a remote server instead of a localized memory. The thin client connects remotely to the server-based computing environment (e.g., cloud banking system 316) where applications, sensitive data, and memory may be stored.

In one embodiment, imagery with a highest confidence score is processed from live video stream check imagery from camera 308, as communicated from an activated camera over a period of time, until an active OCR operation has been completed. For example, a highest confidence scored image in a plurality of images, or partial images, is processed by active OCR system 310 to identify as many data fields as possible. Subsequently, the next highest confidence scored image is processed by active OCR system 310 to extract any data fields missing from the first image OCR and so on until all data fields from the check have been captured. Alternatively, or in addition to, specific required data fields (e.g., amount, MICR, etc.) may be identified first in a first OCR of a highest confidence scored image or partial image, followed by subsequent data fields (e.g., signature) in lower confidence scored mages.

In one embodiment, a recurring transaction system 314 includes an instruction set executable with one or more local computer processing systems or in conjunction with remote computer processing (e.g., a remote server). As described in greater detail in FIGS. 4-7, a recurring transaction may be requested and implemented based on at least a portion of a current check being processed, at least in part, by a remote deposit process. For example, a recurring transaction is scheduled before completion of the remote deposit process. Alternatively, the recurring transaction is scheduled after completion of the remote deposit. In some aspects, the recurring transaction is denied or terminated based on payee, payor or bank actions. For example, the payor requests a recurring transaction and the payee denies the request. In another example, the bank denies the recurring transaction based on insufficient funds, a questionable credit history or suspicion of fraud.

In one aspect, a recurring transaction system 314 is implemented as a series of client-side EFTs. The recurring transaction system 314 includes an instruction set executable with one or more local computer processing systems or in conjunction with remote computer processing (e.g., a remote server). As described in greater detail in FIGS. 4-6, a recurring EFT transaction may be requested and implemented based on at least a portion of a current check being processed, at least in part, by a remote deposit process. For example, a schedule for future EFT transactions is processed before completion of the remote deposit process. Alternatively, the EFT transaction is scheduled after completion of the data field capture for a remote deposit. In some aspects, one or more EFT transactions is denied or terminated based on payee, payor or bank actions, as previously described.

Backend 322, may include one or more system servers processing banking deposit operations in a secure environment. These one or more system servers operate to support client device 302. API 318 is an intermediary software interface between mobile banking app 304, installed on client device 302, and one or more server systems, such as, but not limited to the backend 322, as well as third party servers (not shown). The API 318 is available to be called by mobile clients through a server, such as a mobile edge server (not shown), within cloud banking system 316. File DB stores files received from the client device 302 or generated as a result of processing a remote deposit.

Customer Accounts 324 includes, but is not limited to, a customer's banking information, such as individual, joint, or commercial account information, balances, loans, credit cards, account historical data, etc.

Customer Profiles module 326 retrieves customer profiles associated with the customer from a registry (or other database) after extracting customer data from front or back imagery of the financial instrument. Customer profiles may be used to determine, deposit limits, historical activity, security data, contact information, or other customer related data.

Validation module 328 generates a set of validations including, but not limited to, any of: mobile deposit eligibility, account, image, transaction limits, duplicate checks, amount mismatch, MICR, multiple deposit, recurring transaction eligibility, etc. While shown as a single module, the various validations may be performed by, or in conjunction with, the client device 302, cloud banking system 316, or third party systems or data.

EFT module 329 may generate an electronic transfer of funds based on OCR extracted data fields from the check being deposited by a remote deposit process. EFTs may be instant or include some delay for security or clearing purposes. In addition, EFTs may not be cancelled or recalled. In other words, once an EFT is processed, the funds are deducted from the payor's account and credited to the payee's account.

Recurring transactions platform 330 implements a recurring EFT payment schedule based on a subset of data fields extracted during the OCR process (e.g., name, account number, amount, date, etc.). When the payee processes a check received from a payor, they may request a recurring payment using the same or very similar information. In some aspects, the date and amount may vary based on displaying in UI 306 a range of options and collecting the depositor's subsequent selections. The recurring EFT schedule request may also include, but are not limited to, frequency of occurrences, number of occurrences, date range for recurrence, expiration date, to name a few. The recurring EFT payment schedule may generate a series of EFTs based on an acceptance by the customer through UI 306 of a recurring transactions, according to the given terms. Pending transfer(s) for a recurring EFT payment may be based on a subset (or portion thereof) of data fields extracted during the OCR process (e.g., name, account number, amount, date, etc.). The recurring EFT transaction may be requested through the UI 306 of client device 302. Each time an occurrence of the scheduled recurring EFT request is successful (e.g., deposited), the flow creates a record for the transaction and this function retrieves a product type associated with the account, retrieves the interactions, and generates a series of future pending EFT activities (e.g., scheduled EFTs).

When a remote deposit and recurring transaction status information is generated, it is passed back to the client device 302 through API 318 where it is formatted for communication and display on the client device 302 and may, for example, communicate a recurring EFT schedule for display or rendering on the customer's device through the mobile banking app UI 306. The UI may instantiate the EFT schedule as images, graphics, audio, additional content, etc. In some aspects, the UI may include a request for one or more recurring transactions similar to the current remote deposit. For example, the UI may have a box to check that opens an additional window that provides selectable options for the recurring payments. The selectable options may include, but are not limited to, date, frequency (e.g., monthly, weekly, bi-weekly, etc.), number of recurring payments, notification of unavailable funds, time period for activation (e.g., starting next month until the end of year), etc. In addition, based on the selected options, a message will be generated and forwarded to the payor. The payor's contact information may be derived from data fields on the check, such as account number and retrieved from a customer profile 324 associated with their account number. Alternatively, or in addition to, the messaging may be automated and directed to the payor's banking app as a notification. Alternatively, or in addition to, the message may be an automated call or text message to the payor's telephone number.

Alternatively, or in addition to, one or more components of the remote deposit process may be implemented within the client device 302, third party platforms, the cloud-based banking system 316, or distributed across multiple computer-based systems. The UI may instantiate the remote deposit status as images, graphics, audio, additional content, etc. In one technical improvement over current processing systems, the remote deposit status is provided mid-video stream, prior to completion of the deposit. In this approach, the customer may terminate the process prior to completion if they are dissatisfied with the remote deposit or recurring transaction processes. In some aspects, the remote deposit status may include forward looking status information, for example, a schedule of upcoming recurring transactions and information associated with these transactions (e.g., amount, date frequency, etc.)

In one aspect embodiment, remote deposit system 300 tracks customer behavior. For example, did the payee accept a recurring transaction or did they deny the request? In some aspects, the completion of the recurring transaction operation reflects a successful outcome, while a denial or cancellation reflects a failed outcome. In some aspects, this customer behavior, not limited to success/failure, may be fed back to a ML platform (not shown) to enhance future training of any of ML models. For example, in some embodiments, one or more inputs to the ML models may be weighted differently (higher or lower) to effect a predicted higher successful outcome.

FIG. 4 illustrates an example diagram of a client device 302, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one embodiment, banking app 402 is opened on the client device 302 and the deposit check function selected to initiate a remote deposit process. A camera 308 is activated to initiate a live stream of video from a field of view of the camera 308. The camera may output, for display on user interface (UI) 306 (shown in FIG. 3), one or more video frames having one or more images (e.g., images of real-world objects) that are viewable by camera 308. A video frame may include one or more real-world objects. For instance, a video frame may represent an entire group of checks within a field of view of camera 308, or may represent one or more individual objects within the group. In one aspect, the video frame, or partial video frame of decodable check indicia may be provided by a raw video stream, byte array object(s), as a compressed video stream or byte array, and/or a partially compressed video stream or byte array.

The raw video stream may be detected by an active-pixel sensor 404 (such as a complementary metal-oxide-semiconductor (CMOS) image sensor or a charge-coupled device (CCD). In CCDs, there is a photoactive region (an epitaxial layer of silicon), and a transmission region made out of a shift register. An image is first projected through a lens onto the photoactive region of the CCD, causing each capacitor of a capacitor array to accumulate an electric charge proportional to the light intensity at that location. A one-dimensional array, used in line-scan cameras, captures a single slice of the image, whereas a two-dimensional array, used in video and still cameras, captures a two-dimensional picture corresponding to the scene projected onto the focal plane of the sensor. Once the array has been exposed to the image, a control circuit causes each capacitor to transfer its contents to its neighbor (operating as a shift register). The last capacitor in the array dumps its charge into a charge amplifier, which converts the charge into a voltage. By repeating this process, the controlling circuit converts the entire contents of the array in the semiconductor to a sequence of voltages. These voltages are then sampled, digitized, and may be stored in computer memory within client device 302, such as image memory 312.

In a non-limiting example, the live video streamed image data may be assembled into one or more byte array objects 406 (1-N), such as image blocks, frames, or partial frames, of image content. In one aspect, a data signal from active-pixel sensor 404 (e.g., CMOS or CCD) on camera 308 notifies the banking app 402 when an entire image sensor has been read out as a frame of video. In this approach, the active-pixel sensor 404 is cleared of electrons before a subsequent exposure to light and a next frame of an image generated. This clearing function or frame refresh may be conveyed to the banking app 402, or the active OCR system 310, to indicate that the byte array object constitutes a complete frame of video data. In some aspects, the images from the raw video stream that are formed into byte array objects may be first rectified to correct for distortions based on an angle of incidence, may be rotated to align the imagery, may be filtered to remove obstructions or reflections, and may be resized to correct for size distortions using known image processing techniques. In one aspect, these corrections may be based on recognition of corners or borders of the check as a basis for image orientation and size, as is known in the art.

While any portion of a byte array may be OCR processed during data field captures, in some embodiments, a byte array object 406 (1-N) of an entire frame, or multiple frames, may be OCR processed sequentially until all targeted data fields have been extracted (e.g., as used for an EFT or recurring EFT transaction). For example, multiple images or multiple image portions may be processed to collectively overcome low quality image captures, such as, but not limited to those images that are missing pixels, that include shadowing, that are taken from sharp angles, or that are off-centered, to name a few. In a non-limiting example, a first image may have a right corner missing. A second image may be subsequently OCR processed to capture any data fields that may be located in the missing corner. The technology described herein extracts as many fields from a byte array object, including a frame, or at least a portion of a frame, and continues the extraction process, processing as many images or image portions, until all data fields have been extracted. Continuing from the above example, if only a lower right corner of an image is missing, a byte array substantially formed from pixels originating from the lower right corner of the check image may be OCR processed to capture the missing data field(s) using any of the techniques disclosed herein. Corner and position designations may be generated based on the recognition of check border or edges.

This extracted data may be continuously transmitted, periodically transmitted, or be transmitted after completion of the active OCR process (e.g., after all data fields are extracted), as check data fields to a cloud banking system 316 via a network connection.

In one aspect, imagery of a first side is processed, followed by a flip pause and then processing of second side imagery. Alternatively, or in combination, the first side and second side imagery is processed together or in parallel using the byte array objects formed before and after the flip action.

In one non-limiting example, a series of byte array objects 406 (1-N) are initially formed as sequential sensor frame refresh signals are received. When a recurring transaction request 412 is received during the remote deposit sequence, a recurring data field detector 408 determines that it has data fields necessary (as previously discussed) to generate a recurring EFT schedule, a pause signal stops the forming of byte array objects until the recurring EFT schedule sequence is completed, where a restart signal continues the forming of byte array objects until remaining fields needed for a current remote deposit are completed. Alternatively, or in addition to, the remote deposit and recurring transaction sequences may be processed in parallel, with or without pausing the byte array object builds. Alternatively, one of the two processes may be completed first followed by initiation and completion of the second process. For example, the remote deposit process may be completed followed by a configuration of a recurring transaction using data fields extracted during the remote deposit process.

In one aspect, the recurring deposit process is initiated during the remote deposit process and completed after receiving an acceptance indication from the payor. For example, the remote deposit process may be completed followed by configuration of an EFT schedule for future recurring transactions using data fields extracted during the remote deposit process. In one aspect, in addition to scheduling future recurring EFTs, a current remote deposit process could be cancelled in favor an EFT transaction. In one aspect, accepted recurring EFT transactions could be cancelled (e.g., if the payor/payee changes their mind “before” the transfer is executed, or if there is a technical error (e.g., communication error). In a hybrid aspect, a first amount may be transferred by an EFT and a remaining amount processed by the remote deposit process.

In another aspect, audio, for example spoken words captured by a microphone provided by the client device or broadcast from a speaker on the client device, may support both the remote deposit and recurring transaction sequences. For example, sound may be implemented as speech to aurally request a recurring transaction and associated terms requested by the payee. The payor's response to the request may also be captured and communicated as sound, text, or graphics to the requester. For example, the payor may say yes to the request and a graphic on the requestor's client device may change to a green color.

The technical solution disclosed above implements recurring transactions based on remembrance of a portion of OCR extracted data fields, without first requiring the user to capture individual check images and provide a communication of the image captures to a remote OCR processing system. This solution transforms a written document from a user who may not be familiar or knowledgeable about electronic banking into an electronic banking environment and therefore provides a technical solution only available in a computing environment, as well as the other technical advantages described throughout this disclosure.

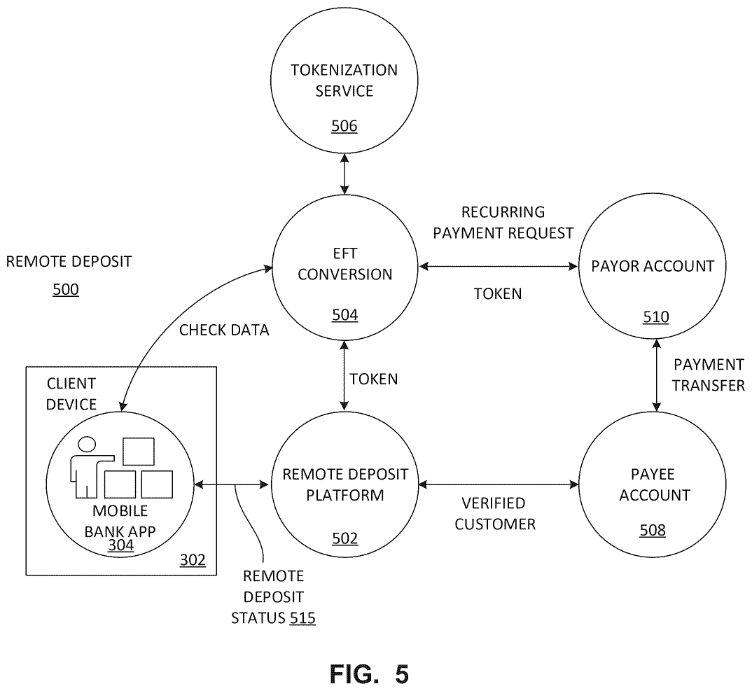

FIG. 5 illustrates an example block diagram of a remote deposit system, according to some embodiments and aspects. The remote deposit 500 system may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In one non-limiting example, a customer using a client device 302 (e.g., smartphone 102), operating a mobile banking app 304, frames at least a portion of a check within a field of view of an active camera of client device 302. As previously described, the imagery within the field of view may, in one aspect, be configured as a live video stream. In one embodiment, forming of image objects (e.g., byte array objects) from a live video stream may be paused during a recurring transaction sequence and then resume the formation of byte array objects when the sequence has been completed. The active OCR 310 extracts data fields from the formed byte array objects. For example, the active OCR extracts or identifies a check date, check number, payer, payee, amount, payee information, and bank information, to name a few.

While extracting identifiable data from surfaces of the check is a primary output of the active OCR, additional post-processing may be needed to further confirm or verify the data. Additional post active OCR processing may include, but is not limited to, verification of data extracted from the fields based on a comparison with historical customer account data found in the payor's account 510, or the payee's account 508. The customer account, for purposes of description, may be the payee's account, the payer's account or both. For example, a payee's account historical information may be used to calculate a payor's funds availability schedule, while a payor's account may be checked for funds to cover the check amount. Customer account identification, may include single or multiple level login data from mobile banking app 304 to initiate a remote deposit. Alternately, or in addition to, the extracted payee field 210 or the payee signature 222 may be used to provide additional authentication of the customer.

In one non-limiting example, an extracted address may be checked against the current address found in a data file of customer account. In another non-limiting example, post active OCR processing may include checking a signature file within customer account to verify the payee or payer signatures. It is also contemplated that a third party database can be checked for funds and signatures for checks from payors not associated with the customer's bank. Additional known OCR post processing techniques may be substituted without departing from the scope of the technology described herein.

In some aspects, active OCR system 310 communicates one or more data fields extracted in the OCR operation to an EFT conversion platform 504. In other aspects, the one or more data fields are communicated to the remote deposit platform 502 and subsequently communicated to the EFT conversion platform 504.

Remote deposit platform 502 (e.g., cloud banking system 316) receives the extracted data fields of the check from the client device 302. In one non-limiting example, single identifiable data fields, such as the check number field 206, date field 208, payee field 210, amount field 212, etc., are sequentially extracted from sequential confidence scored images (e.g., highest score to lowest score) as communicated by the active OCR system 310 in real-time as they are detected and OCR processed. For example the MICR line 220 that includes a string of characters including the bank routing number and the payee's account number, may be processed before other data fields using a highest confidence scored image, or partial image, to immediately initiate a verification of the customer, while the active OCR processes the remaining fields on one or more additional confidence scored images, or partial images. In another non-limiting example, the name, account, date and amount fields may be processed to initiate an EFT and/or recurring EFT process before the remaining data fields have been extracted. Alternatively, or in addition to, the active OCR process may have a time ordered sequence of fields to be processed. Alternatively, or in addition to, all identifiable check fields are processed simultaneously in parallel by the active OCR system 310 across multiple images, or partial images.

Active OCR system 310 communicates one or more data fields extracted in the OCR operation to an EFT conversion 504 (e.g., using EFT module 329). For example, active OCR 310 communicates customer data (e.g., name, address, account number, bank information (e.g., routing information), check number, check amount (e.g., funding amount needed), authorization and anti-fraud information (e.g., signature verifications, watermark or other check security imagery), etc. EFT conversion 504 may return a fixed or dynamically modifiable EFT recurring payment schedule to the UI 306 on the client device 302. EFTs are processed without revealing the payor's or payee's account information. For example, a tokenization service 506, tokenizes the transfer by identifying the transaction by a user identifier, such as, but not limited to, an email address, user name, telephone number, alias, etc. Included within the token are metadata reflecting the date, amount, frequency, time period, termination date, etc. When a payee initiates a remote deposit of one or more current checks, they may request a single or multiple recurring transactions using one or more data fields, as extracted from the one or more checks. For example, in a multiple check embodiment, the payee may request a recurring transaction from the payor of each check or a portion of the checks from the group of checks. A message would be subsequently be sent by any of the previously described methods to obtain the payee's consent. Alternatively, an audit tool or machine learning model may be trained to recognize a pattern of recurring check payments from a payor to a payee and automatically prompt one or both of the payor and payee to initiate a recurring transaction of EFTs according to mutually agreed upon terms. For example, upon observing a series of same amount payments near the beginning of a month, the EFT conversion platform 504 may recommend setting up a recurring transaction of the same amount within a selectable data range encompassing the payment dates.

For remote deposits where the payor declines the request for a recurring EFT, remote deposit platform 502 computes a funds availability schedule based on one or more of the received data fields, customer history received from the payee's account 508, bank funding policies, legal requirements (e.g., state or federally mandated limits and reporting requirements, etc.), or typical schedules stored within a funds availability platform, to name a few. For example, the active OCR system 310 identifies the MICR data as a verified data field that may be used to access a payee's account 508. This access allows the bank identified in the MICR to provide a history of the payee's account 508 to the Remote deposit platform 502. Early access to the customer's account or account information may also provide a verified customer for security purposes to eliminate or reduce fraud early in the remote deposit process. Accordingly, enhancing early fraud detection is a technical improvement of the disclosed technology over existing systems.

Remote deposit platform 502 communicates a remote deposit status 515 to the customer's device. For example, the acceptance of the active OCR processed data or a payee's acceptance of a recurring transaction request, is communicated. Alternatively, a request to continue pointing the camera at one or more sides of the check is communicated to and rendered as on-screen instructions on the client device 302, within one or more user interfaces (UIs) of the customer device's mobile banking app 304. The rendering may include imagery, text, or a link to additional content. The UI may instantiate the remote deposit status 515 as images, graphics, audio, etc. In another technical improvement over existing systems, the remote deposit status is provided mid-video stream, prior to completion of the deposit or recurring transaction. In this approach, the customer may terminate a current if they are dissatisfied with the remote deposit status 515, the EFT conversion 504 (e.g., recurring transaction), or if they identify that an error has occurred.

In one embodiment, remote deposit platform 502 tracks customer behavior. For example, it can assess whether the customer completes a remote deposit operation, recurring transaction, or denies or cancels the request.

Alternatively, or in addition to, one or more components of the remote deposit and recurring transaction flow may be implemented within the customer device, third party platforms, a cloud-based system, distributed across multiple computer-based systems, or combinations thereof.

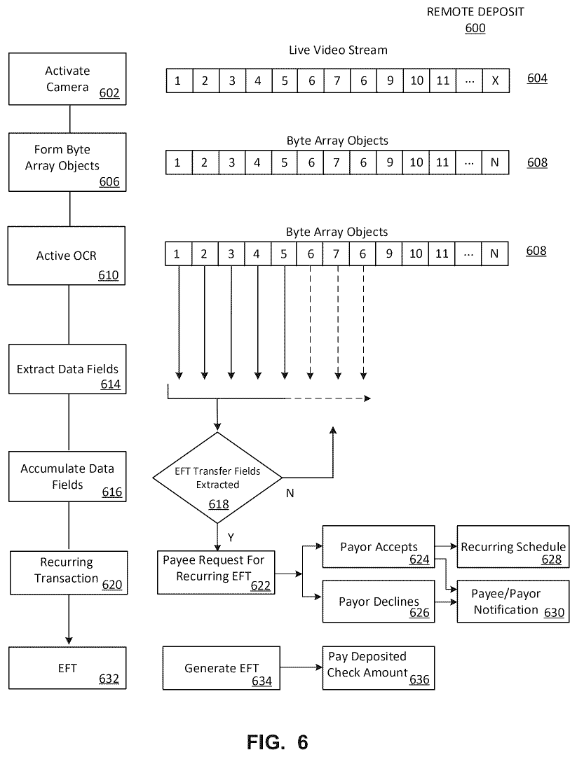

FIG. 6 is a flow chart of a remote deposit 600 depicting an OCR, EFT and recurring transaction process for a remote check deposit that can be carried out in line with the discussion above. One or more of the operations in the method depicted by FIG. 6 may be carried out by one or more entities, including, without limitation, client device 302, cloud banking system 316, remote deposit platform 502, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some aspects, the systems described generate and instantiate an active OCR process for a ranked sequence of confidence scored images in a remote deposit environment.

In 602, a mobile banking app 304 initiates a remote deposit by activating a client device 302 camera. For example, a customer using a mobile computing device, operating a mobile banking app, initiates a remote deposit by selecting this option on a UI of the banking mobile app on their mobile computing device. This selection provides instructions to the camera to communicate image data from the field of view of the camera as a raw live video stream 604 of image data 1, 2, 3 . . . X, where X is a number of pixels of image data.

In 606, the raw live image video stream 604, for example, pixels 1, 2, 3 . . . . X, is converted to byte array objects 608 (1-N), consistent with previously described byte array objects 406 (1-N). In one aspect, the raw live video stream 604 of image data may be continuously formed into byte array objects until an active OCR process has extracted selected data fields from one side of a check. Alternatively, the raw live video stream 604 of image data may be continuously formed into byte array objects until an active OCR process has extracted all data fields from the imagery of both sides of the check. In some aspects, formed byte array objects that capture preprinted border pixels also may be considered in a pre-processing check orientation determination. In this aspect, the previously discussed ML models may be trained to recognize the values that represent the preprinted borders. For example, using machine learning, thousands or millions of images may be processed to learn to accurately recognize and categorize these pixels.

Alternatively, or in addition to, segments or blocks within known data field areas on the check may be processed to determine an initial check orientation and determine a side facing the camera of the client device 302. For example, if the check number data field is recognized by the active OCR 610, it may be determined that the front side of the check is facing up, where a security watermark or signature line may be indicative of a back-side facing. Using supervised learning, thousands or millions of images may be processed to learn to recognize a check type and common data fields and their locations relative to a border or side of a check. Alternatively, or in addition to, the two methods described above may be combined.

In 610, active OCR processes the first and/or second side formed byte array objects to extract a target set of data fields (e.g., for an EFT transaction). As shown in this example (at 614), five data fields were extracted from the first side byte array objects (1-5). The example number of byte array objects used for an active OCR process is shown as five for simplicity purposes. However, the number of byte array objects is not limited and may be a single byte array object or hundreds or even thousands of byte array objects until all desired data fields have been extracted. In addition, the byte array objects may include a full frame of data or be any portion of an image formed from the raw live image video stream 604. For example, as an upper corner of an image is being formed into a byte array and the active OCR system 310, in real-time, extracts any data fields located in this portion of the image. In a non-limiting example, as the customer moves their client device 302 around (e.g., standing over the check with at least a portion of the check in the field of view), a live image video stream 604 is being captured that can be formed into byte array objects and active OCR processed. During active OCR 610, the images may be first rectified to correct for distortions based on an angle of incidence, or may be rotated to align the images, or may be filtered to remove obstructions or reflections and may be resized to allow same size image overlay configurations. In one aspect, these corrections may be based on recognition of corners or borders of the check.

In 616, in some aspects, the forming of byte array objects and accumulating of extracted data fields, may be paused when targeted data fields usable in an EFT have been collected 618. Alternatively, or in addition to, the image objects are continuously formed (e.g., without a pause) and additional data fields to process a remote deposit are extracted.

In 620, a recurring transaction is configured. In 622, a payee request to configure recurring transactions (EFT) results in a communication being generated from the client device (e.g., by mobile banking app 304)), or from the could banking system 316, to the payor with a request to setup a recurring transaction based on the data fields of a current check being remote deposited. While shown as a result of extracting data fields usable with an EFT 618, a payee request for recurring EFT transactions 622 may be sent at any time in the remote deposit sequence, as long as it is sent prior to completion of the remote deposit.

In 632, if the recurring EFT transaction is accepted by the payor 624, an EFT is generated 634 to pay the current deposited check amount into the payee's account 636. In 626, if the recurring EFT transaction is declined or not received within a selectable period of time (e.g., during the remote deposit process time period or for some time period after (e.g., 24 hours)), the remaining data fields for a remote deposit are extracted 614, accumulated 616 and the remote deposit is processed without generating the EFT 634. In 630, payee and payor are kept current with a status of the current deposit, recurring deposits and any subsequent changes.

In 628, a recurring schedule for future recurring EFT deposits (elements 634 and 636) is generated. While not shown, additional communications between the payee and payor may take place as reminders of upcoming EFTs, or to modify future EFTs, to include account updates, amounts, dates, or cancellation.

This approach provides a technical solution to effectively extract data fields from check imagery for both a recurring EFT and remote deposit transaction. For example, a user may move the client device around freely as the camera generates a live video stream of potentially good (in-focus, good lighting, low shading, etc.) and bad quality imagery (e.g., shadows, glare, or off-center) without requiring the user to take a picture or communicate pictures to a remote OCR system, thus allowing for real-time extraction of the check data fields. In addition, an additional technical advantage is achieved by pausing forming byte arrays or active OCR of imagery captured during the EFT generation action. This pause allows an initiation (e.g., in parallel with the current check remote process sequence) of the recurring EFT request 622 from payee to payor and generation of an EFT payment, thus allowing an efficiency of allocating limited client device resources.

While described throughout for active OCR processing, in some aspects, the OCR process may be any process that can extract data fields from the formed byte array objects, including remote systems and processes.

The various aspects solve at least the technical problems associated with performing OCR operations pre-deposit, without requiring communication of an image capture to a remote OCR system. The various embodiments and aspects described by the technology disclosed herein are able to provide active OCR operations and EFT or remote deposit status mid-experience, before the customer completes the deposit and without requiring the customer to provide additional new image captures post image quality or OCR failures.

More specifically, the technical solutions disclosed herein allows video capture of both sides of the financial document (e.g., check), without first requiring the user to stop and start the process to capture individual check images and communication of the image captures to a remote OCR processing system. This solution improves the quality of the check capture process, accelerates the remote check deposit process, and allows mid-video stream alterations or improvements, for example, real-time image quality guidance or customer inputs (e.g., mid-video stream cancelation), as well as the other technical advantages described throughout this disclosure.

This approach provides a technical solution to effectively extract data fields from check imagery and convert to recurring EFT payments, without including a traditional check clearing or funding period. For example, a user may move the client device around freely as the camera generates a live video stream of potentially good (in-focus, good lighting, low shading, etc.) and bad quality imagery (e.g., shadows, glare, or off-center) without requiring the user to take a picture or communicate pictures to a remote OCR system, thus allowing for real-time extraction of the check data fields. In addition, an addition technical advantage is achieved by pausing forming byte arrays or active OCR of imagery that is captured during the EFT generation action. This pause allows an initiation (e.g., in parallel with the current check remote process sequence) of the recurring request 626 from payee to payor for a recurring transaction and generation of an EFT schedule, thus allowing an efficiency of allocating limited client device resources.

While described throughout for active OCR processing, in some aspects, the OCR process may be any process that can extract data fields from the formed byte array objects, including remote systems and processes.

The various aspects solve at least the technical problems associated with performing OCR operations pre-deposit, without requiring communication of an image capture to a remote OCR system. The various embodiments and aspects described by the technology disclosed herein are able to provide active OCR operations and remote deposit status mid-experience, before the customer completes the deposit and without requiring the customer to provide additional new image captures post image quality or OCR failures.

### Example Computer System

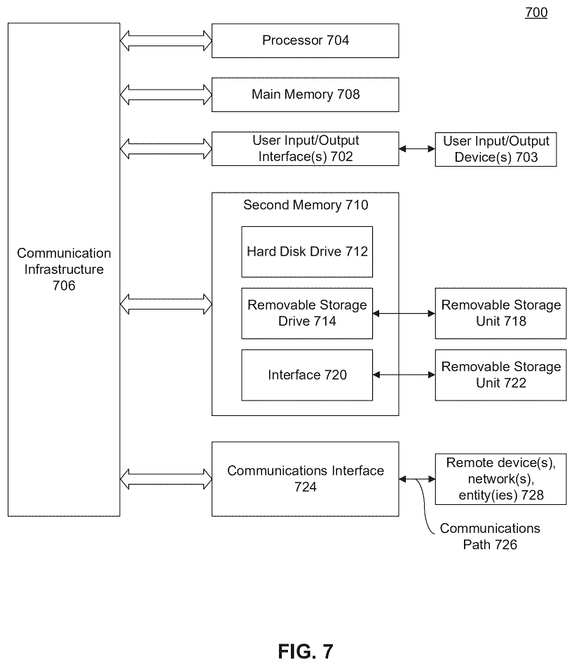

FIG. 7 depicts an example computer system useful for implementing various embodiments.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 700 may include one or more processors (also called central processing units, or CPUs), such as a processor 704. Processor 704 may be connected to a communication infrastructure or bus 706.

Computer system 700 may also include user input/output device(s) 702, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 718 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 716 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A computer-implemented method using a client device, the method comprising:
receiving, from a client device, a plurality of optical character recognition (OCR) extracted data fields from a physical financial document;
accumulating the OCR extracted data fields until a first subset of the OCR extracted data fields has been accumulated, wherein the first subset includes a first portion of data fields from the physical financial document usable in an Electronic Funds Transfer (EFT) transaction;
generating a schedule of recurring EFT transactions, based at least in part, on the first portion of data fields; and
generating, based on the schedule of recurring EFT transactions, a series of pending EFT transactions.

2. The computer-implemented method of claim 1, wherein the generating the schedule of recurring EFT transactions further comprises providing any of: a recurring date equal to an OCR extracted date field of the physical financial document, a recurring date range proximate to an OCR extracted date field of the physical financial document, a payee requested date, a payor requested date, or a bank selected date.

3. The computer-implemented method of claim 1, wherein the generating the schedule of recurring EFT transactions further comprises:
receiving, from the client device, a request for generating the recurring EFT transactions;
communicating the request for the recurring EFT transactions to an originator of the physical financial document; and
receiving, from the originator of the physical financial document an indication of acceptance, wherein the originator of the physical financial document is a payor.

4. The computer-implemented method of claim 3, further comprising: when the first portion of the data fields of the physical document includes at least a payor data field, payee data field, amount data field, and date field, executing a first pending occurrence in the series of pending EFT transactions by electronically transferring, from the payor to the payee, an amount from the amount data field.

5. The computer-implemented method of claim 4, further comprising: terminating, based on executing the first pending occurrence of the series of pending EFT transactions, the accumulating of the OCR extracted data fields.

6. The computer-implemented method of claim 3, further comprising: terminating, based on not receiving the indication of acceptance, the schedule of recurring EFT transactions.

7. The computer-implemented method of claim 3, further comprising: terminating, based on not receiving the indication of acceptance within a selectable time period, the schedule of recurring EFT transactions.

8. The computer-implemented method of claim 3, further comprising:
accumulating, based on not receiving the indication of acceptance, the OCR extracted data fields until a second subset of extracted data fields has been accumulated.

9. The computer-implemented method of claim 8, further comprising:
completing a remote deposit process from a plurality of the OCR extracted data fields from the first subset and the second subset.

10. A system, comprising:
a memory; and
at least one processor coupled to the memory and configured to:
receive, from a client device, a plurality of optical character recognition (OCR) extracted data fields from a physical financial document;
accumulate the OCR extracted data fields until a first subset of the OCR extracted data fields has been accumulated, wherein the first subset includes a first portion of data fields from the physical financial document usable in an Electronic Funds Transfer (EFT) transaction;
generate a schedule of recurring EFT transactions, based at least in part, on the first portion of data fields; and
generate, based on the schedule of recurring EFT transactions, a series of pending EFT transactions.

11. The system of claim 10, wherein the at least one processor is further configured to generate the schedule of recurring EFT transactions based on any of: a recurring date equal to an OCR extracted date field of the physical financial document, a recurring date range proximate to an OCR extracted date field of the physical financial document, a payee requested date, a payor requested date, or a bank selected date.

12. The system of claim 10, further configured to:
receive, from the client device, a request for generating the recurring EFT transactions;
communicate the request for the recurring EFT transactions to an originator of the physical financial document; and
receive, from the originator of the physical financial document an indication of acceptance, wherein the originator of the physical financial document is a payor.

13. The system of claim 12, further configured to:
when the first portion of the data fields of the physical document includes at least a payor data field, payee data field, amount data field, and date field, execute a first pending occurrence in the series of pending EFT transactions by electronically transferring, from the payor to the payee, an amount from the amount data field.

14. The system of claim 13, further configured to:
terminate, based on executing the first pending occurrence, the accumulating of the OCR extracted data fields.

15. The system of claim 12, further configured to:
terminate, based on not receiving the indication of acceptance, the schedule of recurring EFT transactions.

16. The system of claim 12, further configured to:
terminate, based on not receiving the indication of acceptance within a selectable time period, the schedule of recurring EFT transactions.

17. The system of claim 12, further configured to:
accumulate, based on not receiving the indication of acceptance, the OCR extracted data fields until a second subset of extracted data fields has been accumulated.

18. The system of claim 17, further configured to:
complete a remote deposit process from a plurality of the OCR extracted data fields from the first subset and the second subset.

19. A non-transitory computer-readable device having instructions stored thereon that, when executed by at least one computing device, causes the at least one computing device to perform operations comprising:
receiving, from a client device, a plurality of optical character recognition (OCR) extracted data fields from a physical financial document;
accumulating the OCR extracted data fields until a first subset of the OCR extracted data fields has been accumulated, wherein the first subset includes a first portion of data fields from the physical financial document usable in an Electronic Funds Transfer (EFT) transaction;
generating a schedule of recurring EFT transactions, based at least in part, on the first portion of data fields; and
generating, based on the schedule of recurring EFT transactions, a series of pending EFT transactions.

20. The non-transitory computer-readable device of claim 19, wherein the generating the series of pending EFT transactions further comprises operations:
receiving, from the client device, a request for generating the recurring EFT transactions;
communicating the request for the recurring EFT transactions to an originator of the physical financial document; and
receiving, from the originator of the physical financial document an indication of acceptance, wherein the originator of the physical financial document is a payor.
